(19) United States
(12) Patent Application Publication
(10) Pub. No.: US 2023/0220620 A1
(43) Pub. Date: Jul. 13, 2023

(54) CONTINUOUS STEAM EXPLOSION METHOD AND A DEFIBRATION SYSTEM

(71) Applicant: VALMET AB, Sundsvall (SE)

(72) Inventors: Francois LAMBERT, Sundsvall (SE); Mattias ERIXON, Härnösand (SE); Andreas AVERHEIM, Sundsvall (SE); Peter BJÖRKLUND, Umeå (SE)

(73) Assignee: VALMET AB, Sundsvall (SE)

(21) Appl. No.: 18/007,532

(22) PCT Filed: Apr. 28, 2021
(86) PCT No.: PCT/SE2021/050388

§ 371 Date: Dec. 1, 2022

(30) Foreign Application Priority Data
Jun. 3, 2020 (SE) 2050638-2

(51) Int. Cl. D21B 1/36

(52) U.S. Cl. CPC D21B 1/36

(57) ABSTRACT

The present invention relates to a method for defibrating a lignocellulosic material in a steam explosion process, the method comprising: —supplying (1001) lignocellulosic material to a reactor (8), —treating (1002) the lignocellulosic material in the reactor (8) at a first pressure (P1), —discharging (1003) the lignocellulosic material from the reactor (8) to a vessel (13), wherein the vessel (13) is at a second pressure (P2) that is lower than the first pressure (P1) so that the lignocellulosic material is defibrated through steam explosion as it passes from the reactor (8), wherein lignocellulosic material is continuously supplied to and discharged from the reactor (8) in such a way that the first pressure (P1) is constant. The invention also relates to a defibration system for defibrating a lignocellulosic material in a steam explosion process.

### TECHNICAL FIELD

The present invention relates to a method for defibrating a lignocellulosic material in a steam explosion process, the method comprising supplying lignocellulosic material to a reactor, treating the lignocellulosic material in the reactor at a first pressure, and discharging the lignocellulosic material from the reactor to a vessel, wherein the vessel is at a second pressure that is lower than the first pressure so that the lignocellulosic material is defibrated through steam explosion as it passes from the reactor.

### BACKGROUND

When producing pulp from a lignocellulosic material, one commonly known method of disintegrating fibers of the lignocellulosic material is through steam explosion. This takes place after the lignocellulosic material has undergone hydrolysis that serves to soften lignin and release hemicellulose, and the steam explosion is performed by rapidly discharging the lignocellulosic material from a pressurized reactor through a valve or small opening into a second vessel that is held at significantly lower pressure than the reactor. When fibers are ejected in this way, they expand suddenly due to the pressure drop as they move from the reactor at elevated pressure into the second vessel at the lower pressure, and this expansion causes a disintegration of the fibers. Such disintegration due to an abrupt lowering of pressure is known as steam explosion or a steam explosion process and is well known within the field of pulping.

Steam explosion generally also requires a supply of steam to the pressurized reactor in order to increase or control pressure to ensure that the pressure drop at discharge is sufficient to explode the fibers and disintegrate them.

The pulp produced in this way is generally used to produce pellets or briquettes, but other end products may also be achieved. Several known methods and defibrator systems for achieving steam explosion of lignocellulosic material that has undergone hydrolysis are known within the art. However, these prior art methods and systems are generally inefficient and costly and there is a great need for improvements that can provide high quality results while also minimizing cost an increasing efficiency.

One prior art method and system within this field is disclosed by SE1850793 A1 and discloses a way of decreasing cost by minimizing the use of steam for steam explosion. Another prior art method is shown by FR3087790 and discloses another way of minimizing cost by drying lignocellulosic material prior to introduction in a reactor so that steam consumption can be decreased.

Typical problems with the prior art methods and systems are uneven pressure drop at the steam explosion leading to quality problems, and difficulty to treat large quantities of steam that is released.

### SUMMARY

The object of the present invention is to eliminate or at least to minimize the problems discussed above. This is achieved by a method and a defibrator system according to the appended independent claims.

The inventive method for defibrating a lignocellulosic material in a steam explosion process comprises supplying lignocellulosic material to a reactor, treating the lignocellulosic material in the reactor at a first pressure, and discharging the lignocellulosic material from the reactor to a vessel. The vessel is at a second pressure that is lower than the first pressure so that the lignocellulosic material is defibrated through steam explosion as it passes from the reactor. Also, the method comprises continuously supplying and discharging lignocellulosic material to and from the reactor in such a way that the first pressure is constant.

It is a particular advantage that lignocellulosic material can undergo steam explosion in a continuous process, where the material is continuously supplied to the reactor and also continuously discharged from the reactor. Thereby, an even production rate is achieved, and energy consumption can be kept at an even rate to avoid fluctuations. To maintain a constant first pressure is also highly advantageous in ensuring that the steam explosion results in a disintegrated lignocellulosic material of high and even quality, thereby avoiding situations where a fluctuating first pressure could result in some fibers of the lignocellulosic material being unevenly disintegrated or withstanding disintegration altogether so that larger unexploded fibers remain in the lignocellulosic material after steam explosion.

Prior art methods and systems are generally concerned with developing different ways of minimizing cost for performing steam explosion, often by limiting the quantity of steam needed to treat the lignocellulosic material in the reactor or to allowing for steam explosion to take place with a decreased or variable pressure drop. However, although efficient for limiting steam consumption such prior art methods generally suffer from lower and uneven quality of the steam exploded lignocellulosic material. It is a main benefit of the present invention that a high and even quality can be achieved in a predictable and convenient way as described herein.

Suitably the method further comprises supplying steam to the reactor, preferably with a continuous supply of steam. Thereby, the use of steam is rendered cost and energy efficient, since situations where large quantities of steam are required within a short period of time are avoided. Instead, a steady supply of steam allows for performing the method with only a limited steam production capacity, which provides a significant saving in cost as well as energy.

Also, a level of lignocellulosic material in the reactor may be constant. This ensures that a duration that the lignocellulosic material is treated in the reactor is constant, resulting in the hydrolyzation of the lignocellulosic material being uniform for all lignocellulosic material that passes through the reactor. This in turn is advantageous in providing a uniform pulp that may be used to form end products from the lignocellulosic material.

Suitably, the second pressure is also constant. Thereby, the pressure drop from the reactor to the vessel is constant, resulting in a controlled and uniform steam explosion of the lignocellulosic material during operation.

The lignocellulosic material may also be dried before it is supplied to the reactor. Thereby, moisture levels in the lignocellulosic material is lower as it enters the reactor than would otherwise be the case, and this in turn is energy saving since heating the lignocellulosic material to reach an elevated temperature requires less energy when the lignocellulosic material is dryer. Suitably, the lignocellulosic material is dried until it reaches a moisture content of 6-8% which is beneficial both in the amount of energy required to dry the lignocellulosic material and the energy required to then heat the dried material.

The method may further include recovering vapor comprising volatile organic compounds (VOC) from the reactor or from the vessel or a conduit between the reactor and the vessel. Thereby the volatile organic compounds are removed from the lignocellulosic material so that undesired emissions during later stages of production is avoided and so that the volatile organic compounds can be recovered. Suitably, the recovered vapor comprises furfural.

Also, the method suitably comprises recovering steam from the reactor or from the vessel or a conduit between the reactor and the vessel. Thereby, the recovered steam can be re-used in the steam explosion process or in other treatment steps of the lignocellulosic material to produce pulp.

Suitably, the lignocellulosic material is treated at a temperature of 170-215° C. in the reactor. Thereby, hydrolysis can take place in an efficient way so that the lignocellulosic material is prepared for being steam exploded.

The present invention also comprises a defibration system for defibrating a lignocellulosic material in a steam explosion process. The system comprises a reactor for treating a lignocellulosic material, a reactor inlet for supplying lignocellulosic material into the reactor and a reactor outlet for discharging lignocellulosic material from the reactor. Also, the system comprises a vessel operatively connected to the outlet for receiving lignocellulosic material discharged from the reactor. The system is further arranged to continuously supply and discharge lignocellulosic material to and from the reactor through the reactor inlet and the reactor outlet in such a way that a first pressure in the reactor is constant. Furthermore, the vessel is configured to maintain the lignocellulosic material at a second pressure that is lower than the first pressure in order to defibrating the lignocellulosic material as it is discharged from the reactor outlet. Thereby, the advantages noted above with reference to the method according to the invention are achieved.

Suitably, the system also comprises a dryer for drying the lignocellulosic material, said dryer being operatively connected to the reactor inlet so that lignocellulosic material can pass from the dryer into the reactor inlet. Thereby, moisture content of the lignocellulosic material can be lowered significantly before entering the reactor, so that the lignocellulosic material can be heated in a more energy efficient way.

The system may also comprise a steam inlet for supplying steam into the reactor. Thereby, steam can be added to adjust the pressure inside the reactor and can also serve to heat the lignocellulosic material.

Suitably, the system also comprises a steam outlet for recovering steam from the reactor or the vessel or from a conduit between the reactor and the vessel. Thereby, excess steam can be discharged from the reactor for lowering the first pressure if desired, and steam can also be recovered from the vessel after the lignocellulosic material has undergone steam explosion. Alternatively, steam can be recovered from a conduit in which the lignocellulosic material is transported from the reactor before being discharged into the vessel.

Also provided may be a vapor recovery outlet in the reactor for recovering volatile organic compounds from the reactor. This enables removal of volatile organic compounds that have been released from the lignocellulosic material, so that emissions of such compounds during later stages of treatment for the lignocellulosic material can be avoided. The volatile organic compounds may be transported to a storage tank or to a recovery system in which potentially valuable substances among the volatile organic compounds may be separated from the others. Such substances suitably include furfural.

Suitably, the vessel is further configured to maintain the second pressure at a constant level so that a pressure difference between the first pressure in the reactor and the second pressure in the vessel is constant. This allows for a constant pressure drop from the reactor to the vessel and ensured a uniform steam explosion of the lignocellulosic material to arrive at a high quality pulp.

Also, the defibration system may comprise a control unit that is configured to control supply and discharge of lignocellulosic material to and from the reactor. Thereby, a convenient and efficient operation of the reactor may be achieved by the control unit operating at least the reactor inlet and reactor outlet so that supply and discharge of lignocellulosic material are adjusted. This in turn allows the control unit to control the pressure inside the reactor.

In some embodiments, the control unit is also configured to control supply of steam and recovery of steam and/or volatile organic compounds to and from the reactor. Thereby, an even more efficient control of the pressure inside the reactor may be achieved.

Many additional benefits and advantages of the present invention will be readily understood by the skilled person in view of the detailed description below.

### DRAWINGS

The invention will now be described in more detail with reference to the appended drawings, wherein

FIG. 1 discloses a defibrator system according to the present invention; and

FIG. 2 discloses schematically the method according to the present invention.

All the figures are schematic, not necessarily to scale, and generally only show parts which are necessary in order to elucidate the respective embodiments, whereas other parts may be omitted or merely suggested. Any reference number appearing in multiple drawings refers to the same object or feature throughout the drawings, unless otherwise indicated.

### DETAILED DESCRIPTION

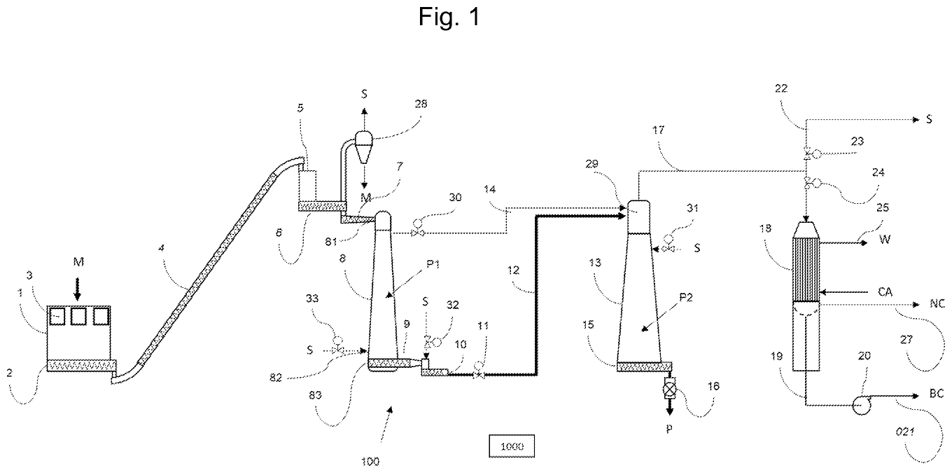

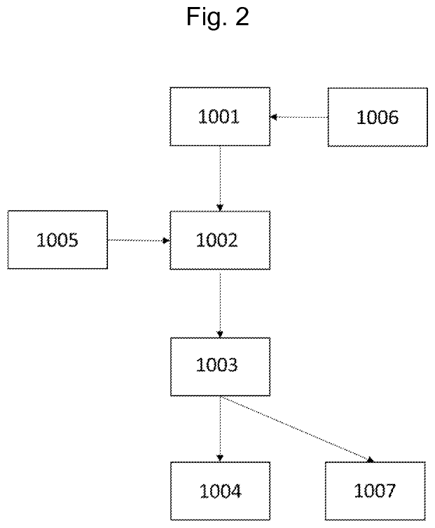

In the following, a defibration system for defibrating a lignocellulosic material in a steam explosion process according to a preferred embodiment of the present invention will be described in detail with reference to FIG. 1. Also, the method for defibrating a lignocellulosic material in a steam explosion process according to the invention will also be described with reference to FIG. 2.

The term lignocellulosic material is used herein to mean materials containing lignin, cellulose and hemicellulose. One example of such material is wood, others include other agricultural or forestry wastes.

When it is stated herein that a first component is in fluid communication with a second component, this is to be interpreted as the components being connected in such a way that a space is formed inside the first component and extends up to and at least partly inside the second component. A parameter detected in that space would then have a constant or near constant value in the space so that the parameter as detected in the space is constant across the space.

When the term constant is used herein this is to be interpreted as being the same value within manufacturing tolerances, or a detected parameter not varying more than 10%.

The terms upstream and downstream as used herein refer to how lignocellulosic material passes through the defibration system. Thus, a downstream direction will be a direction along which a flow of lignocellulosic material passes, whereas an upstream direction will be a direction against the flow of lignocellulosic material.

FIG. 1 discloses a preferred embodiment of a defibrator system 100 according to the present invention. After passing through the defibrator system 100, the lignocellulosic material M has been processed to form a pulp P that may suitably be pressed to form pellets or briquettes, but that may alternatively also be used for other end products as well.

Lignocellulosic material M enters a storage bin 1 where it can be stored until transported by a first screw 2 in a downstream direction. The lignocellulosic material M in the storage bin 1 may be raw material in the form of wood, bark, bagasse and/or straw that is suitably split up into chips, flakes or splinters, but may alternatively be such raw material that has already undergone a pre-treatment. Suitably, the lignocellulosic material M has also undergone a screening for removal of unwanted parts such as sand or gravel that could cause wear and blockages in the defibrator system 100 and other components through which the lignocellulosic material M passes.

In some embodiments, a dryer 3 may be integrated with the storage bin 1 or may alternatively be provided before or after the storage bin 1 so that the lignocellulosic material can be dried to a lower moisture content. This is advantageous in reducing energy required for heating the lignocellulosic material M further downstream. Suitably, a moisture content of the lignocellulosic material M after drying is 6-8%.

In other embodiments, the lignocellulosic material M is not subjected to a drying step. This may be advantageous in requiring less pre-treatment of the lignocellulosic material before hydrolysis.

Lignocellulosic material M is transported from the storage bin 1 by the first screw 2 and optionally also by at least one scraper provided in the storage bin 1 to facilitate transport of the lignocellulosic material M. In this embodiment, the lignocellulosic material M is then transported along a first conveyor 4 to a level bin 5 that serves as a short-time storage for the lignocellulosic material M before it enters a reactor 8. Supply to the level bin 5 may be controlled by a chip level control present in the level bin 5 that operates the first screw 2 and the conveyor 4 so that a constant level of lignocellulosic material M in the level bin 5 is achieved. This is beneficial in ensuring that there is always a supply of lignocellulosic material M that can be continuously fed into the reactor 8 during operation of the defibrator system 100. The level bin 5 may be operated at atmospheric pressure and is provided with a second screw 6 that is operated to provide a constant flow of lignocellulosic material to a third screw 7. Said third screw 7 is suitably in the form of a plug screw that serves to compress the lignocellulosic material M and provide a hard plug to ensure that a pressure difference can be maintained between atmospheric pressure upstream of the reactor 8 and an elevated pressure inside the reactor 8 itself. Both the second screw 6 and the third screw 7 operate continuously in order to transport lignocellulosic material M into the reactor 8 via a reactor inlet 81, and the plug formed by the third screw 7 is continuously disintegrated as it enters the reactor 8. A steam inlet 82 is also provided to allow for a supply of steam S to enter the reactor 8, preferably through a first steam valve 33.

Also provided in connection with the second screw 6 is a blow back cyclone 28 that serves as a safety cyclone in case the reactor 8 is depressurized backwards. This would result in the steam S and lignocellulosic material M flowing backwards through the third screw 7 if for some reason the third screw 7 were to fail in providing the plug that continuously seals the reactor 8 so that the elevated pressure may be maintained inside.

In such events, lignocellulosic material M and steam S may be evacuated through the blow back cyclone 28 but during normal operation it is to be expected that all the lignocellulosic material M and steam S that are present in the second screw 6 will also enter the reactor 8.

Supply to the reactor 8 is in this preferred embodiment shown in the form of the second screw 6 and the third screw 7, but it is to be noted that other components could alternatively be used to supply lignocellulosic material M into the reactor 8, as long as such components are able to provide a continuous feeding of lignocellulosic material M into the reactor 8 and as long as the reactor 8 can be maintained at the elevated pressure.

Inside the reactor 8, the lignocellulosic material M is heated to an elevated temperature, preferably 170-215° C., by means of the steam S or optionally also by other heating means in the reactor 8. The lignocellulosic material M is transported through the reactor 8 from the reactor inlet 81 in an upper end of the reactor 8 to a reactor outlet 83 provided in a lower part of the reactor 8. As it passes through the reactor 8 the lignocellulosic material M undergoes hydrolysis in order to separate substances contained in the lignocellulosic material M from each other. Such substances mainly include hemicellulose, lignin and cellulose, but other substances such as a plurality of volatile organic compounds (VOC) may also be released from the lignocellulosic material M inside the reactor 8.

Volatile organic compounds and other gases may be removed from the reactor 8 by means of a relief valve 30 that serves as a vapor recovery outlet and be transported from the defibrator system 100 for subsequent recovery. In the preferred embodiment of FIG. 1 the transport takes place in a gas conduit 14 to a vessel 13 and further on through a second gas conduit 17 where the gas from the reactor 8 is added to gas emitted in the vessel 13 in the second gas conduit 17. The volatile organic compounds contain some valuable substances like furfural that may be separated from other substances and from used steam. The recovery of steam and some such substances are disclosed briefly below.

A fourth screw 9 is provided at the reactor outlet 83 and transports hydrolyzed lignocellulosic material M from the reactor 8, optionally also by means of a fifth screw 10 to an orifice or opening 11 that may be provided in the form of a valve with an adjustable or constant opening. The fourth screw 9, the fifth screw 10 and the opening 11 are all in fluid communication with the reactor 8 and forms part of the reactor outlet 83. The fifth screw 10 is preferably a rotating mixer that aids in transporting the lignocellulosic material M towards the opening 11.

In some embodiments, other components may be used instead to discharge lignocellulosic material M from the reactor 8 as long as a continuous output of lignocellulosic material M through the opening 11 can be achieved.

Inside the reactor 8 the lignocellulosic material M is treated at a first pressure P1 that is kept constant throughout the reactor 8, and at the opening 11 the lignocellulosic material M is discharged into the vessel 13, or into a conduit 12 that is in fluid communication with the vessel 13, that is held at a second pressure P2 that is significantly lower than the first pressure P1. Due to a sharp pressure drop from the first pressure P1 to the second pressure P2 at the opening 11, the lignocellulosic material M that passes through the opening 11 is suddenly expanded and undergoes a steam explosion that disintegrates fibers of the lignocellulosic material M. It is advantageous to maintain the second pressure P2 at a constant level so that the pressure drop is also kept constant, since this allows for creating a uniform pulp from the lignocellulosic material M where the fibers have all undergone steam explosion and been disintegrated to smaller particles in a uniform way. The second pressure P2 may suitably be atmospheric pressure or close thereto (e.g. 0.01 bar) but other levels of pressure are also suitable as long as they differ from the first pressure P1 so that steam explosion can take place. In the preferred embodiment, the opening 11 is a blow valve with an adjustable or a fixed orifice through which the lignocellulosic material M is discharged. The first pressure P1 is typically in the range 10-25 bar and may differ depending on properties of the lignocellulosic material M and desired parameters of the hydrolysis in the reactor 8, as long as a sufficiently large pressure drop is achieved at the opening 11 so that steam explosion can take place.

The reactor 8 is able to maintain an elevated pressure by the reactor inlet 81 and the reactor outlet 83 sealing the reactor 8 from other parts of the system and from ambient air. At the reactor inlet 81, the third screw 7 that is suitably a plug screw as shown in FIG. 1 provides a plug that prevents a flow in an upstream direction so that no lignocellulosic material or gas such as steam or vapor is allowed to escape through the reactor inlet 81. It is to be noted that the reactor inlet 81 could also include other ways of preventing the elevated pressure in the reactor from escaping and that the plug screw is to be seen as one suitable alternative for this. Similarly, at the reactor outlet 83 the fourth screw 9 and optionally fifth screw 10 transport the lignocellulosic material to the opening 11 where controlled discharge takes place so that any unwanted release of lignocellulosic material and/or steam through the reactor outlet 83 is prevented. Thereby, the reactor 8 forms a zone of uniform pressure that is maintained at the first pressure P1.

Discharge of lignocellulosic material M from the reactor 8 is continuous due to a continuous operation of the fourth screw 9 and the fifth screw 10. By continuously supplying lignocellulosic material M through the reactor inlet 81 and continuously discharging hydrolyzed lignocellulosic material M through the reactor outlet 83 a continuous operation of the reactor 8 is achieved. This is particularly advantageous in limiting the amount of steam S that is required at any given time for heating the lignocellulosic material M and increasing pressure in the reactor 8, so that a steam generator used for producing the steam can be kept at a significantly lower capacity than would be the case in a discontinuous operation of the reactor 8. For discontinuous processes such as a batch process a very large quantity of steam is needed during a short space of time in order to heat and pressurize lignocellulosic material, resulting in a higher production cost and the need for a considerably larger steam generator. It also requires an increased capacity for recovering steam after use, resulting in a more expensive defibrator system.

Thus, the main advantages associated with the present invention are achieved through the continuous operation with a steady supply of lignocellulosic material M to the reactor 8 and also steady discharge of lignocellulosic material M from the reactor 8. Furthermore, by maintaining the first pressure P1 at a continuous level the steam explosion can take place in an efficient way resulting in a high-quality pulp. The first pressure P1 is held constant through adjusting the supply and discharge of lignocellulosic material M so that a suitable quantity of lignocellulosic material M is held in the reactor 8 at any given time. Optionally, an additional control of the first pressure P1 is also achieved by adjusting the supply of steam S through the steam inlet 82 and/or a removal of gas through the relief valve 30. By controlling these parameters, the first pressure P1 is set and maintained during operation of the reactor 8 so that the benefits associated with the present invention can be achieved. Suitably, additional steam S may be supplied through a second steam valve 32 at the reactor outlet 83 to ensure that the first pressure P1 is maintained all the way to the opening 11. Preferably, the additional steam S is injected between the fourth screw 9 and the fifth screw 10.

After the lignocellulosic material M has passed the opening 11 and been subjected to the steam explosion, it is transported further downstream into a vessel 13 that is preferably in the form of a blow tank 13. A conduit 12 may be provided in connection with the opening 11 to transport the lignocellulosic material M to the vessel 13, or alternatively the vessel 13 may be placed immediately downstream of the opening 11 so that the lignocellulosic material M enters the vessel 13 through the opening 11. The conduit 12 is preferably in fluid communication with the vessel 13 so that both the conduit 12 and the vessel 13 are held at the second pressure P2.

The vessel 13 preferably comprises a cyclone 29 where steam S is separated from the lignocellulosic material M. Gases removed from the reactor 8 and transported to the vessel 13 in the gas conduit 14 may also be supplied to the cyclone 29 and be removed along with the steam S through a second gas conduit 17 from the vessel 13 to a condenser 18.

In the reactor 8, steam S in the range 0.4-0.6 ton for each ton of dry lignocellulosic material M with a moisture range of 6-8% is typically used. The steam S mostly serves to heat the lignocellulosic material M and the remaining water contained therein. The gas that may be removed through the relief valve 30 typically comprises volatile organic compounds (VOC) that are released from the lignocellulosic material M and that contain furfural and other volatile hydrocarbons. In FIG. 1, the gases are transported to the condenser 18 together with steam S that is recovered in the cyclone 29, but the VOC could instead be transported to a condensing and fractioning system for recovery of by-product chemicals (not shown).

The lignocellulosic material M is held in the reactor 8 during a predetermined time in order for hydrolysis to proceed until a desired P-factor is reached. The duration is determined at a certain production capacity by controlling a level of lignocellulosic material M in the reactor 8 and also by controlling the temperature and the first pressure P1. This is well known in the art and will not be described in more detail herein.

Typically, the duration may be 20 minutes. It is advantageous to maintain the level of lignocellulosic material M constant since this ensures that the duration is also kept constant with a constant supply and discharge of lignocellulosic material M. This in turn also ensures that the lignocellulosic material M that undergoes steam explosion at the opening 11 is disintegrated to the same degree so that the resulting pulp P has a uniform and even quality.

Suitably, the vessel 13 is sealed from ambient air to prevent access to oxygen which could otherwise create a risk of fire in the vessel 13. Also, to further prevent the undesired entry of air into the vessel, steam S may be supplied through a third steam valve 31 if needed to prevent the second pressure P2 from decreasing below a pressure of ambient air that would otherwise risk causing entry of said ambient air into the vessel 13 through possible leakages in the vessel 13 or components attached thereto.

Lignocellulosic material M in the form of pulp P exits the defibrator system 100 through a vessel outlet 16, preferably by use of a sixth screw 15 arranged in a bottom end of the vessel 13. The pulp may then be used for producing an end product, such as pellets or briquettes that is created by the pulp being pressed. Other end products may however also be suitable, as is well known to the skilled person.

Also provided is the condenser 18 that serves to recover blow steam from the defibrator system 100 and to separate substances from the steam for subsequent recovery. Thus, the condenser 18 receives blow steam from the vessel 13, and the blow steam comprises steam S that is supplied further upstream as well as steam obtained from water and volatile hydrocarbons that evaporate from the lignocellulosic material M during treatment in the defibrator system 100. The condenser 18 is preferably in the form of a vertical tube and shell heat exchanger with the blow steam inside tubes and a cooling agent or coolant CA on a shell side. A blow steam condensate BC, containing condensable hydrocarbons and furfural, is collected in a bottom part of the condenser 18 and may be transferred through a first condenser outlet 19 to a separate system for recovery of chemicals and/or an effluent treatment system, suitably by means of a pump 20. The blow steam that enters the condenser 18 also comprises non-condensable gases NC that are separated from the blow steam and removed through a second condenser outlet 27. Furthermore, hot water W may be recovered from the condenser 18 through a water outlet 25 and used elsewhere in the defibrator system 100, particularly advantageously as a heat source for drying the lignocellulosic material M before it is supplied into the reactor 8.

In some embodiments the condenser 18 may be replaced by a conduit 22 that directs steam S from the vessel 13 to a separate system (not shown) for recovery, storage or re-use of the steam S. In the preferred embodiment of FIG. 1, the condenser 18 is provided together with that conduit 22, and valves 23, 24 are provided so that flow of steam S can be directed either to the condenser 18, to the conduit 22, or both as desired.

Also shown in FIG. 1 is a control unit 1000 that is suitably configured to at least partly control operation of the system. In some embodiments, the control unit 1000 controls the supply and discharge of lignocellulosic material to and from the reactor 8 by controlling operation of the reactor inlet 81 and the reactor outlet 83. Controlling the reactor inlet 81 may be done by controlling operation of the third screw 7, e.g. by controlling rotational speed of the third screw 7 in order to adjust a supply rate to the reactor 8. In some embodiments, the second screw 6 may also be controlled by the control unit 1000, and optionally also the conduit 4, since this further increases control over the supply rate of lignocellulosic material to the reactor 8. Similarly, controlling the reactor outlet 83 may be done by controlling the fourth screw 9 in order to adjust the discharge rate of lignocellulosic material, e.g. by controlling rotational speed of the fourth screw 9. In some embodiments, the fifth screw 10 may also be controlled and optionally also the opening 11 where a blow valve or similar may be arranged. Also, in some embodiments the control unit 1000 may be configured to control supply and removal of steam to and from the reactor 8 by operating the first steam valve 33 and the relief valve 30.

The control unit 1000 may thus control operation of the whole of the system or only some components, but at least the reactor inlet 81 and the reactor outlet 83.

The control unit 1000 may be operatively connected to the system or to components of the system by a wireless connection as shown in FIG. 1 but optionally instead by other kinds of connections so that command signals from the control unit 1000 may be transmitted to components of the system and may operate said components. Such connections are well known within the art and will not be described in more detail herein. In some embodiments, the control unit 1000 may also be configured to receive input signals from the system or from at least one component of the system. Such input signals may give information regarding current operation of the system or of operational parameters such as pressure in any part of the system.

The method for defibrating a lignocellulosic material according to the present invention will now be described in more detail, with reference to FIG. 1 and also to FIG. 2 that schematically discloses steps of the method.

According to the inventive method, lignocellulosic material M is supplied 1001 to the reactor 8 through the reactor inlet 81. The lignocellulosic material M is then treated 1002 in the reactor 8 at the first pressure P1 before being discharged 1003 through the reactor outlet 83 to the vessel 13 that is held at the second pressure P2. By the second pressure P2 being significantly lower than the first pressure P1, the lignocellulosic material M undergoes steam explosion as it passes from the reactor outlet 83 to the vessel 13 or to a conduit 12 that is in fluid communication with the vessel 13. The first pressure P1 is kept constant by a continuous supply 1001 and discharge 1003 of lignocellulosic material M as described in detail above.

In the preferred embodiment, steam S is supplied 1005 to the reactor 8, preferably continuously, so that the lignocellulosic material M is heated and pressurized while treated 1002.

Also, the lignocellulosic material M is preferably dried 1006 before supplying 1001 it to the reactor 8.

The method also comprises recovering 1004 vapor comprising organic compounds from the reactor 8 and/or from the vessel 13 as described above. The vapors or gas or blow steam containing such vapors or gas preferably comprise furfural.

After the lignocellulosic material M has been discharged 1003 from the reactor 8, steam S is recovered 1007 further downstream, either at the vessel 13 or in other components arranged in connection with the vessel 13.

It is to be noted that features from the various embodiments described herein may freely be combined, unless it is explicitly stated that such a combination would be unsuitable.

1. Method for defibrating a lignocellulosic material in a steam explosion process, the method comprising:
supplying lignocellulosic material to a reactor,
treating the lignocellulosic material in the reactor at a first pressure (P1),
discharging the lignocellulosic material from the reactor to a vessel, wherein the vessel is at a second pressure (P2) that is lower than the first pressure (P1) so that the lignocellulosic material is defibrated through steam explosion as it passes from the reactor,
wherein lignocellulosic material is continuously supplied to and discharged from the reactor, and wherein the supply and discharge of lignocellulosic material is adjusted in such a way that the first pressure (P1) is constant.

2. Method according to claim 1, further comprising supplying steam to the reactor, preferably with a continuous supply of steam.

3. Method according to claim 1, wherein a level of lignocellulosic material in the reactor is constant.

4. Method according to claim 1, wherein the second pressure (P2) is constant.

5. Method according to claim 1, further comprising drying the lignocellulosic material before it is supplied to the reactor.

6. Method according to claim 5, wherein the lignocellulosic material is dried until it reaches a moisture content of 6-8%.

7. Method according to claim 1, further comprising recovering vapor comprising volatile organic compounds from the reactor or from the vessel or a conduit between the reactor and the vessel.

8. Method according to claim 7, wherein the vapor comprises furfural.

9. Method according to claim 1, further comprising recovering steam from the reactor or from the vessel or a conduit between the reactor and the vessel.

10. Method according to claim 1, wherein the lignocellulosic material is treated at a temperature of 170-215° C. in the reactor.

11. Defibration system for defibrating a lignocellulosic material in a steam explosion process, the defibration system comprising
a reactor for treating a lignocellulosic material,
a reactor inlet for supplying lignocellulosic material into the reactor,
a reactor outlet for discharging lignocellulosic material from the reactor,
a vessel operatively connected to the outlet for receiving lignocellulosic material discharged from the reactor,
wherein the system is arranged to continuously adjust supply and discharge of lignocellulosic material to and from the reactor through the reactor inlet and the reactor outlet in such a way that a first pressure (P1) in the reactor is constant, and wherein the vessel is further configured to maintain the lignocellulosic material at a second pressure (P2) that is lower than the first pressure (P1) in order to defibrating the lignocellulosic material as it is discharged from the reactor outlet.

12. Defibration system according to claim 11, further comprising a dryer for drying the lignocellulosic material, said dryer being operatively connected to the reactor inlet so that lignocellulosic material can pass from the dryer into the reactor inlet.

13. Defibration system according to claim 11, further comprising a steam inlet for supplying steam into the reactor.

14. Defibration system according to claim 11, further comprising a steam outlet for recovering steam from the reactor or the vessel or from a conduit between the reactor and the vessel.

15. Defibration system according to claim 11, further comprising a vapor recovery outlet in the reactor for recovering volatile organic compounds from the reactor.

16. Defibration system according to claim 11, wherein the vessel is configured to maintain the second pressure (P2) at a constant level so that a pressure difference between the first pressure (P1) in the reactor and the second pressure (P2) in the vessel is constant.

17. Defibration system according to claim 11, further comprising a control unit that is configured to control supply and discharge of lignocellulosic material to and from the reactor and optionally also to control supply of steam and recovery of steam and/or volatile organic compounds to and from the reactor.
